(19) United States
(12) Patent Application Publication
(10) Pub. No.: US 2026/0213167 A1
(43) Pub. Date: Jul. 23, 2026

(54) NEGATIVE ACTIVE MATERIAL, LITHIUM SECONDARY BATTERY CONTAINING THE SAME

(71) Applicant: EBS SQUARE, Inc., Seongnam-si (KR)

(72) Inventors: Sung Won HWANG, Hwaseong-si (KR); Min Kyoung Na, Seoul (KR); Hyun Hee Jung, Seoul (KR)

(73) Assignee: EBS SQUARE, Inc., Seongnam-si (KR)

(21) Appl. No.: 19/367,933

(22) Filed: Oct. 24, 2025

(30) Foreign Application Priority Data
Jan. 17, 2025 (KR) 10-2025-0007148

(51) Int. Cl. H01M 4/36; H01M 4/02; H01M 4/485; H01M 4/583; H01M 10/052

(52) U.S. Cl. CPC H01M 4/366; H01M 4/485; H01M 4/583; H01M 10/052; H01M 2004/021; H01M 2004/027

(57) ABSTRACT

The negative active material according to an embodiment may include a silicon-based active material composite; and a carbon-based active material, wherein the silicon-based active material composite may include silicon oxide (SiOx, 0<x≤2), titanium oxide (TiOx, 0<x≤2), and a carbon material.

### CROSS-REFERENCE TO RELATED APPLICATION(S)

This application claims benefit of priority to Korean Patent Application No. 10-2025-007148 filed on Jan. 17, 2025 in the Korean Intellectual Property Office, the disclosure of which is incorporated herein by reference in its entirety.

### BACKGROUND

### 1. Field

The present disclosure relates to a negative active material including a silicon-based active material and having improved electrical capacity, electrochemical characteristics, and structural stability, and a lithium secondary battery containing the same.

### 2. Description of Related Art

Recently, the electric vehicle market is expected to grow by approximately forty-fold or more by 2030. Conventional lithium secondary batteries have a limited energy density of 810 Wh/l, whereas next-generation lithium secondary batteries are required to have an energy density of 1,000 Wh/l or more. Accordingly, the necessity to increase capacity of the lithium secondary batteries has increased. The demand for the lithium secondary batteries has continuously increased due to the growth of the electric vehicle market, and the lithium secondary batteries have been widely used due to their advantages such as a high energy density, a long cycle lifespan, and high stability. However, the conventional lithium secondary batteries primarily use a graphite negative electrode material having a low-capacity (374 mAh/g), and thus, has a difficulty in meeting requirements such as a high energy density of batteries for electric vehicles. In order to meet the market demand for secondary batteries having a high energy density, research into materials and structures for improving the energy density of the lithium secondary batteries has been actively conducted.

In order to improve the energy density of the lithium secondary batteries, silicon oxide (SiOx) has been mainly studied as a negative electrode material. The silicon oxide has a higher capacity than a carbon material and exhibits more excellent cycle stability and initial efficiency than silicon (Si). However, the silicon oxide has low electrical conductivity, and causes continuous formation and a change of a solid electrolyte interphase (SEI) layer at an interface with an electrolyte due to volume expansion during charge/discharge, resulting in low initial efficiency and rapid capacity degradation. During an initial lithiation process, the silicon oxide reacts with the electrolyte, such that lithium oxide (Li₂O) and lithium silicate (LixSiOy) are formed to mitigate a large volume change and exhibit improved cycle performance. Nevertheless, the formed lithium oxide and lithium silicate irreversibly consume lithium ions and cause volume expansion of the silicon oxide. For this reason, a structure becomes unstable and a non-uniform SEI layer is formed, such that electrochemical performance deteriorates.

In order to solve such a problem, research into a composite of silicon oxide (SiOx) and a transition metal has been conducted.

### SUMMARY

An aspect of the present disclosure provides a negative active material capable of having excellent electrochemical performance and outstanding stability by including a silicon-based active material composite formed in a core-shell structure.

Another aspect of the present disclosure provides a negative active material capable of having high capacity by including a silicon negative electrode material and having excellent cycle characteristics due to its structural stability.

According to an embodiment, a negative active material may include a silicon-based active material composite; and a carbon-based active material, wherein the silicon-based active material composite may include silicon oxide (SiOx, 0<x≤2), titanium oxide (TiOx, 0<x≤2), and a carbon material.

The silicon-based active material composite may include a core including silicon oxide (SiOx, 0<x≤2) and titanium oxide (TiOx, 0<x≤2), and a shell including a carbon material.

The core may have a structure in which the silicon oxide (SiOx, 0<x≤2) forms an amorphous matrix and the titanium oxide (TiOx, 0<x≤2) is embedded within the matrix.

The carbon material may include a carbon quantum dot (CQD).

The CQD may have an average particle size of 1 to 100 nm.

The silicon oxide (SiOx, 0<x≤2) may be included in an amount more than or equal to 3 wt % and less than 25 wt % based on 100 parts by weight of the negative active material.

The titanium oxide may have an average particle size of 0.5 to 50 nm.

The titanium oxide may include an anatase-type TiO₂.

The silicon-based active material composite may have an average particle size (D₅₀) of 1 to 10 um.

The carbon-based active material may include at least one of natural graphite, artificial graphite, and amorphous carbon.

The carbon-based active material may be included in an amount more than or equal to 50 wt % and less than 97 wt % based on 100 parts by weight of the negative active material.

According to another embodiment, a lithium secondary battery may include a negative electrode including the negative active material as described above; a positive electrode including a positive active material; and an electrolyte that transfers lithium ions to the positive electrode and the negative electrode.

### BRIEF DESCRIPTION OF THE DRAWINGS

FIG. 1 is a schematic diagram illustrating a negative active material.

FIG. 2 shows scanning electron microscope (SEM) and transmission electron microscope (TEM) images of the negative active material, with enlarged views specifically showing the silicon-based active material composite.

FIG. 3 shows the rate capability of a battery using the negative active material based on the silicon-based active material composite at various current densities.

FIG. 4 shows the coulombic efficiency and cycle characteristics of a battery using the silicon-based active material composite as the negative active material.

FIG. 5 shows the charge/discharge characteristics of a battery using the silicon-based active material composite as the negative active material.

### DETAILED DESCRIPTION

Throughout the present specification, like reference numerals refer to like components. It should be noted that the present specification does not describe all elements of the embodiments, and well-known techniques in the art to which the present disclosure pertains, as well as repetitive descriptions among the embodiments, are omitted.

Throughout the present specification, when a certain portion is “connected” to another portion, this includes not only a direct connection but also an indirect connection, such as a connection via a wireless communication network.

Furthermore, when a certain portion is described as “including” a specific component, it should be understood that unless explicitly stated otherwise, this does not exclude the presence of other components, and the portion may further include other components.

A singular expression, unless the context clearly indicates otherwise, includes the corresponding plural forms.

In addition, the terms such as “~unit,” “~er/or,” “~block,” “~member,” and “~module” may refer to a unit that processes at least one function or operation. For example, the above terms may refer to at least one hardware such as a field-programmable gate array (FPGA) or an application-specific integrated circuit (ASIC), at least one software stored in a memory, or at least one process executed by a processor.

Reference numerals assigned to respective steps are used for identifying the steps, and do not indicate the order of the steps. Unless the context clearly specifies a particular order, the steps may be carried out in an order different from that described.

Hereinafter, embodiments of a solid electrolyte according to an aspect and a secondary battery containing the same will be described in detail with reference to the accompanying drawings. The embodiments described herein and the configurations illustrated in the drawings are merely exemplary of the most preferred embodiment of the present disclosure, and various equivalents or variations may be substituted therefor as of the filling date of this application.

### <Negative Active Material>

A negative active material 1 is a compound capable of reversibly intercalating and deintercalating lithium ions.

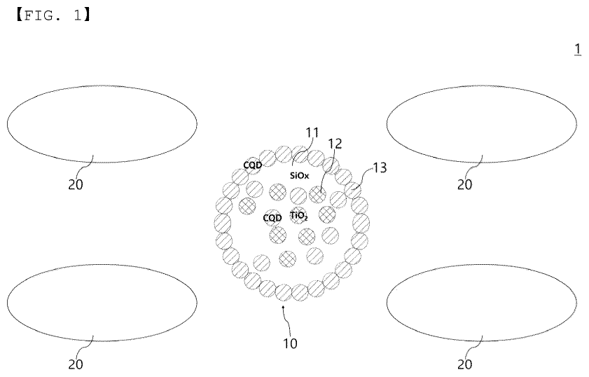

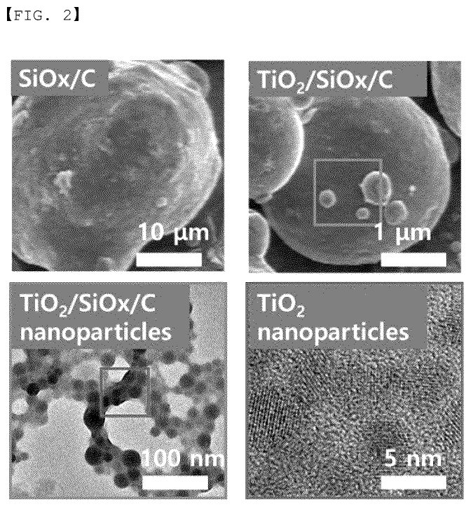

FIG. 1 is a schematic diagram illustrating a negative active material, and FIG. 2 shows scanning electron microscope (SEM) and transmission electron microscope (TEM) images of the negative active material, with enlarged views specifically showing the silicon-based active material composite.

The negative active material 1 may include a silicon-based active material composite 10 and a carbon-based active material 20.

Referring to FIGS. 1 and 2, the silicon-based active material composite 10 may include silicon oxide 11, titanium oxide 12, and a carbon material 13. Here, the silicon-based active material composite 10 may include a core that includes silicon oxide 11 and titanium oxide 12, and a shell that includes a carbon material 13 and surrounds the core.

The silicon oxide 11 may be SiOx (0<x≤2). In addition, the silicon oxide 11 may have a form in which silicon particles are incorporated into an SiO₂ structure.

The silicon oxide 11 may be obtained by a known sublimation method in which a mixture of silicon dioxide and metallic silicon is heated to produce silicon monoxide gas, which is subsequently cooled and precipitated. Alternatively, the silicon oxide 11 may be obtained commercially as silicon oxide, silica monoxide, etc.

The silicon oxide 11 may be included in an amount more than or equal to 3 wt % and less than 25 wt % based on 100 parts by weight of the negative active material 1. Preferably, the silicon oxide 11 may be included in an amount of 5 wt % to 20 wt % based on 100 parts by weight of the negative active material 1.

The silicon oxide 11 may form an amorphous matrix structure, in which titanium oxide 12 may be embedded, thereby forming a core. The core may be surrounded and encapsulated by a shell made of carbon material 13 as described below, to form a silicon-based active material composite 10.

In addition, carbon nanoparticles or carbon quantum dots (CQDs) may be embedded within the matrix of the silicon oxide 11, together with titanium oxide 12, to form a core.

The titanium oxide 12 may be provided as TiOx (0<x≤2). The titanium oxide 12 may be embedded within the matrix of silicon oxide 11 and, together with the silicon oxide 11, may form the core of the silicon-based active material composite 10. This core forms a silicon-based active material composite 10, which is surrounded by a shell made of carbon material 13.

The titanium oxide 12 may be provided as anatase-type TiO₂ and may be provided as nanoparticles.

According to an embodiment, the titanium oxide 12 may be included in an amount of 1 to 10 wt % based on 100 parts by weight of the negative active material.

According to an embodiment, the titanium oxide 12 may have an average particle size of 0.5 to 50 nm, and preferably about 5 nm.

Titanium oxide 12 generally exhibits long cycle stability due to its chemically stable structure and small volume change, but is not used for lithium-ion batteries due to its low electronic conductivity and poor ion diffusivity.

However, according to an embodiment of the present disclosure, the titanium oxide 12 may lower interfacial resistance by using nanostructured titanium oxide 12 to increase lithium-ion conductivity, and may expand the ion diffusion path by using it in a composite with a material having good electronic conductivity, such as a carbon material.

In addition, to solve the low-capacity problem of titanium oxide 12, it may be used in a composite with silicon oxide to solve the problem of conventional titanium oxide.

The carbon material 13 may be a material made of carbon and may include a carbon quantum dot (CQD).

According to an embodiment, the carbon material 13 may be provided as a CQD and may be included in an amount of 0.1 to 10 wt % based on 100 parts by weight of the negative active material.

According to an embodiment, the CQD may have an average particle size of 1 to 100 nm, and preferably about 10 nm.

The carbon material 13 may be provided in a shell structure and formed to surround a core that includes the silicon oxide 11 and titanium oxide 12. That is, the carbon material 13 may have a form in which it partially or entirely coats a surface of the core. Preferably, the carbon material 13 may coat the surface of the core at a uniform thickness.

According to an embodiment, the carbon material 13 may be provided as a CQD and may be provided in a shell structure surrounding the core at a thickness of about 10 nm.

As a result, the silicon-based active material composite 10 is encapsulated by a shell made of carbon material 13, resulting in improved electronic conductivity.

The silicon-based active material composite 10 is a ternary nanocomposite including nanostructured titanium oxide 12, high-capacity silicon oxide 11, and highly conductive carbon material (13). Accordingly, the composite exhibits electrochemical performance, excellent ionic conductivity, abundant hierarchical porosity, and stable structural characteristics.

Furthermore, the silicon-based active material composite 10 has the effect of improving stability by buffering stress changes due to volume changes during charge/discharge through a core-shell structure.

The carbon-based active material 20, together with the silicon-based active material composite 10, constitutes the negative active material 1, which enables the reversible intercalation and deintercalation of lithium ions.

The carbon-based active material 20 may be selected from at least one of natural graphite, artificial graphite, and amorphous carbon, and may be used alone or in combination of two or more.

The carbon-based active material 20 may be included in an amount of 50 wt % to 99 wt % based on 100 parts by weight of the negative active material, and preferably 60 wt % to 95 wt % based on 100 parts by weight of the negative active material.

Since the carbon-based active material 20 is included in a greater weight percentage than the silicon-based active material composite 10, the carbon-based active material 20 may have a form in which it surrounds the silicon-based active material composite 10.

### <Negative Electrode>

The negative electrode includes a current collector, and a negative electrode material layer formed on the current collector and including a negative active material, a conductive agent, a binder, etc. For example, the negative electrode of the present disclosure may be obtained by preparing a coating slurry by mixing a negative active material, a binder, a conductive agent, a thickener, and a solvent such as an organic solvent or water, applying the coating slurry onto the current collector, drying the solvent or water, and then forming a negative active material layer by press-molding. The current collector may be made of, for example, copper, and carbon black (Super-P) may be used as a conductive agent.

The binder is not particularly limited and may include, for example, styrene-butadiene copolymers; (meth)acrylic copolymers obtained by copolymerizing ethylenically unsaturated carboxylic acid esters, such as methyl (meth)acrylate, ethyl (meth)acrylate, butyl (meth)acrylate, (meth)acrylonitrile, and hydroxyethyl (meth)acrylate, with ethylenically unsaturated carboxylic acids, such as acrylic acid, methacrylic acid, itaconic acid, fumaric acid, and maleic acid; and polymer compounds such as polyvinylidene fluoride, polyethylene oxide, polyepichlorohydrin, polyphosphazene, polyacrylonitrile, polyimide, and polyamideimide.

The binder may be included in an amount of 0.1 wt % to 20 wt % in the negative electrode material layer.

When the binder content is 0.1 wt % or more, the adhesion tends to be improved, and the destruction of the negative electrode caused by expansion and contraction during charge/discharge tends to be suppressed. Meanwhile, when the binder content is 20 wt % or less, an increase in electrode resistance tends to be suppressed.

Preferably, the slurry may be prepared by mixing the negative active material, conductive agent, and binder in a weight ratio of 85:10:5.

### <Lithium Secondary Battery>

A lithium secondary battery according to the present disclosure includes a positive electrode, the negative electrode, and an electrolyte.

The lithium-ion secondary battery may be formed, for example, by arranging a positive electrode to face a negative electrode through a separator, and then injecting an electrolyte.

The positive electrode may be obtained by forming a positive active material layer on the surface of the current collector, similar to the negative electrode. The positive electrode current collector may be made of, for example, aluminum.

The positive active material of the positive electrode material layer of the lithium secondary battery according to the present disclosure is a compound capable of reversibly intercalating and deintercalating lithium ions. Specifically, the positive active material may include a lithium metal oxide containing lithium and one or more metals, such as cobalt, manganese, nickel, or aluminum. Examples of the lithium metal oxide include lithium-manganese-based oxide lithium-cobalt-based oxide, lithium-nickel-based oxide, lithium-cobalt-nickel-based oxide, lithium-nickel-manganese-cobalt-based oxide, or lithium iron phosphate.

The electrolyte is not particularly limited and any known electrolyte may be used. For example, a non-aqueous lithium-ion secondary battery may be manufactured by using a liquid electrolyte prepared by dissolving an electrolyte in an organic solvent. Examples of electrolytes include LiPF₆, LiClO₄, LiBF₄, LiClF₄, LiAsF₆, LiSbF₆, LiAlO₄, LiAlCl₄, LiN(CF₃SO₂)₂, LiN(C₂F₅SO₂)₂, LiC(CF₃SO₂)₃, LiCl, and LiI. The organic solvent may be any solvent capable of dissolving the electrolyte. Examples of organic solvents include propylene carbonate, ethylene carbonate, diethyl carbonate, ethyl methyl carbonate, vinyl carbonate, γ-butyrolactone, 1,2-dimethoxyethane, and 2-methyltetrahydrofuran.

On the other hand, the electrolyte is not limited to liquid electrolytes and may also be a solid electrolyte.

As the separator, any known separator may be used. Specific examples include paper separators, polypropylene separators, polyethylene separators, and glass fiber separators.

However, when a solid electrolyte is used, the separator may not be included in the lithium secondary battery.

### Example 1

### Preparation of Negative Active Material

First, SiOx nanoparticles were synthesized through a volatilization-condensation process using an induction heating apparatus. Si was placed in a graphite crucible, and the graphite crucible, surrounded by a copper foil, was subjected to an electric current to melt the Si. Then, a gas mixture of O₂ and Ar was introduced to evaporate SiOx. After 2 hours of synthesis, the electric current was reduced to cool the synthesized SiOx nanoparticles, which were condensed in the chamber. The titanium raw material, titanium tetrabutoxide (TBOT), tetraethyl orthosilicate (TEOS), and p-phthalic acid (PTA), serving respectively as the titanium raw material, silicon raw material, and organic ligand, were uniformly dispersed in a mixed solvent of N,N-dimethylformamide and methanol, 5 g of p-phthalic acid was added to the mixed solution, followed by 50 mL of DMF and 5 mL of methanol. The mixture was stirred for 30 minutes, and then titanium tetrabutoxide (TBOT) and tetraethyl ether were added. The mixture was stirred for 30 minutes and then stored at 180° C. for 12 hours. The TiO₂/SiOx was collected by centrifugation, washed three times with DMF, dried twice with methanol, and then heat-treated at 650° C. in N₂ for 4 h to obtain TiO₂/SiOx/C. TiO₂/SiOx/C was obtained through a solvothermal process. Then, after subsequent annealing under a nitrogen atmosphere, a porous ternary TiO₂/SiOx/C nanocomposite was synthesized.

To synthesize a graphite/SiO₂ composite as a negative active material for lithium secondary batteries, graphite powder (<20 μm, Sigma-Aldrich) and tetraethyl orthosilicate (TEOS, Sigma-Aldrich), a silicon oxide precursor, were used. Graphite and TEOS were mixed at a weight ratio of 93.9:6.1 with ethanol and stirred at room temperature for 8 hours. Ammonia solution (Sigma-Aldrich) was then added to adjust a pH to 9. After 10 hours of stirring, sonication was carried out for 2 hours. Thereafter, the solvent was evaporated in an oven at 90° C., and the resulting material was heat-treated in a furnace at 450° C. for 4 hours at a heating rate of 5° C./min. During the calcination, the argon gas flow rate was set to 50 cc/min, resulting in final synthesis of TiO₂/SiOx/C.

### Manufacture of Lithium Secondary Battery and Electrochemical Characterization

The negative active material prepared above used to manufacture a negative electrode for the lithium secondary battery. A slurry was prepared by mixing the negative active material, conductive agent, and binder at a weight ratio of 85:10:5. The negative active material described above was used as the active material, Super-P (Sigma-Aldrich) was used as the conductive agent, and polyvinylidene fluoride (PVDF) (Sigma-Aldrich) was used as the binder. The slurry was prepared by adjusting the viscosity with 1-methyl-2-pyrrolidinone (NMP) (Sigma-Aldrich), and was subsequently coated onto a copper foil, serving as a current collector at a thickness of 200 μm. Thereafter, the coated electrode was dried in an oven at 100° C. for 12 hours, and then pressed using a hot press at 150° C. under a pressure of 4,000 psi to achieve a uniform thickness. The coated electrode was densified via a rolling process on a roll press to increase the electrode density, and coin cells were manufactured in an argon-filled glove box under oxygen- and moisture-free conditions to measure the electrochemical characteristics of the synthesized materials. In the coin cell, a Li metal was used as the counter electrode, a polypropylene (PP) (Wellcos) was used as the separator, and an electrolyte solution composed of a 1 M LiPF₆ salt dissolved in a mixed solvent of ethylene carbonate (EC) and dimethyl carbonate (DMC) at a volume ratio of 1:1 was used as the electrolyte.

To analyze the electrochemical characteristics of the silicon-based active material composite, the powder resistivity of the material was measured using a powder resistivity measurement system. The measurements were performed under applied pressures of 300 to 2,000 kgf/cm². The electrical conductivity of the silicon-based active material composite was measured and compared with composites prepared under different conditions to analyze electrical conductivity characteristics. The cycle performance, rate capability, and impedance analysis of the manufactured coin cells were evaluated using a WBCS 3,000 battery cycler (Won A Tech). The operating voltage range was set to 0.1 to 2.5 V, and charge/discharge tests were performed at 0.5 C, 1.0 C, and 2.0 C, based on a theoretical capacity of 370 mAh/g. Cyclic voltammetry electrochemical experiment were conducted at an operating voltage of 0.1 to 2.5 V with scan rates of 0.5, 1.0, 1.5, and 2.0 mV/s, using a ZIVE LAB MP2 (Won A Tech). Through cyclic voltammetry tests, a periodic voltage was applied to the electrode/electrolyte interface, and the resulting current response was measured to predict the reactions occurring in the battery.

### Example 2

Example 2 was conducted under the same conditions as in Example 1, except that only the contents of graphite, silicon oxide, titanium oxide, and CQD were changed to 86.5 wt %, 10 wt %, 3 wt %, and 0.5 wt %, respectively.

### Example 3

Example 3 was conducted under the same conditions as in Example 1, except that only the contents of graphite, silicon oxide, titanium oxide, and CQD were changed to 79 wt %, 15 wt %, 5 wt %, and 1 wt %, respectively.

### Example 4

Example 4 was conducted under the same conditions as in Example 1, except that only the contents of graphite, silicon oxide, titanium oxide, and CQD were changed to 60 wt %, 20 wt %, 10 wt %, and 10 wt %, respectively.

### Comparative Example

The Comparative Example was conducted under the same conditions as in Example 3, except that 1 wt % of SWCNT was used instead of 1 wt % of CQD.

TABLE 1

| | Exam- | Exam- | Exam- | Exam- |
|---|---|---|---|---|
| | ple | ple | ple | ple |
| Items | 1 | 2 | 3 | 4 |
| CQDs Carbon Content (wt %) | 0.1 | 1 | 1 | 10 |
| Silicon Content (wt %) | 5 | 10 | 15 | 20 |
| Titanium Content (wt %) | 1 | 3 | 5 | 10 |
| Graphite Contents | 93.9 | 86.5 | 79 | 60 |
| Average Particle Size | 5 | 5 | 5 | 5 |
| D₅₀(μm) | | | | |
| Carbon Quantum Dot (CQD) | 10 | 10 | 10 | 10 |
| Size (nm) | | | | |
| Titanium (Ti) Nanoparticle | 5 | 5 | 5 | 5 |
| Size (nm) | | | | |
| Raman Value (D/G) | 1 | 1 | 1 | 1.1 |
| First Charge Capacity | 1976 | 2137 | 2268 | 2547 |
| Discharge Capacity after | 1745 | 1979 | 2027 | 2319 |
| 500 Cycles | | | | |
| Charge/Discharge | 99.5 | 99.7 | 98.7 | 98.5 |
| Efficiency (0.5 C) | | | | |
| Charge/Discharge | 99.4 | 99.5 | 98.6 | 98.4 |
| Efficiency (1 C) | | | | |
| Charge/Discharge | 98.5 | 98.7 | 97.7 | 97.5 |
| Efficiency (2 C) | | | | |
| Swelling Ratio | 3 | 3 | 4 | 5 |

Table 1 shows the evaluation results of the lithium-ion battery unit cells manufactured according to Examples 1 to 4. Referring to Examples 1 to 4 of the present disclosure, it can be seen that as the silicon oxide content increases, the capacity increases while the charge-discharge efficiency remains stable at about 97% or more.

TABLE 2

| | Initial | Charge/ | |
|---|---|---|---|
| Structure | Capacity | Discharge | Resistance |
| Si (15 wt %) | 3,416 | 2,078 | 4.6 × 10⁻⁸ |
| w/CQD 1 wt % | mAh/g | mAh/g | Ωm |
| Si (15 wt %) | 3,031 | 1,612 | 5.2 × 10⁻⁸ |
| w/SWCNT 1 wt % | mAh/g | mAh/g | Ωm |

Referring to Table 2, it can be seen that Example 3 of the present disclosure exhibits superior electrical conductivity characteristics (due to lower resistance), which allows the intercalation and deintercalation of ionized particles within the negative active material to be maximized, compared to the Comparative Example where SWCNT was applied.

### <Physical Property Evaluation>

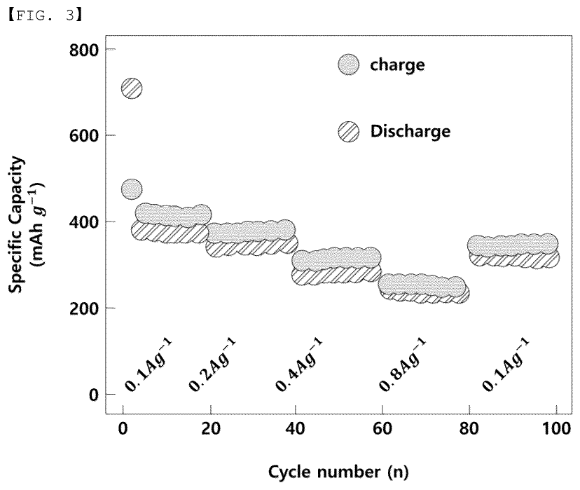

FIG. 3 shows the rate capability of a battery using the negative active material based on the silicon-based active material composite at various current densities.

Referring to FIG. 3, when a battery was manufactured using a silicon-based active material composite as a negative active material, it exhibited a capacity retention of 97.5% or more over 100 cycles at C-rates of 0.5 C, 1 C, and 2 C.

When 86.5 wt % graphite (carbon-based active material) was used in combination with the silicon-based active material composite as the negative active material (Example 2), the battery maintained a higher capacity at C-rates of 0.5 C, 1 C, and 2 C compared to a battery using 93.9 wt % graphite (carbon-based active material) (Example 1). It also exhibited high cycle stability of 99% or more at 0.5 C. This improvement in cycle stability results from uniform formation of an SEI layer by surface modification of the silicon-based active material composite particles with SiOx. The improved capacity and cycle characteristics are attributed to increased specific surface area and reduced resistance at heterogeneous interfaces within the battery.

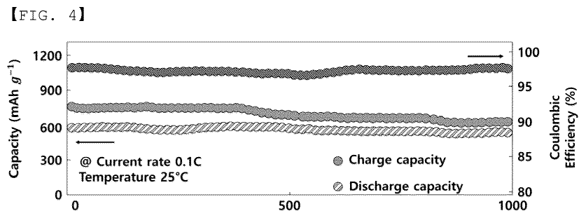

FIG. 4 shows the coulombic efficiency and cycle characteristics of a battery using the silicon-based active material composite as the negative active material.

Referring to FIG. 4, at a current density of 1 A g⁻¹, the silicon-based active material composite exhibited a high reversible specific capacity of 589 mAh g⁻¹ with 89% capacity retention after 1,000 cycles. The poor long-cycle performance of the TiO₂/C structure may be due to the lower conductivity of rutile TiO₂, which has fewer pores and oxygen vacancies than anatase TiO₂, and to the fact that rutile TiO₂ permits Li⁺ diffusion only along the c-axis. This result indicates that the silicon-based active material composite (TiO₂/SiOx/C) exhibits better ionic conductivity and faster Li⁺ diffusion. Additionally, the silicon-based active material composite (TiO₂/SiOx/C) structure was well maintained even after 1,000 cycles at 1 A g⁻¹. The cycle stability of the silicon-based active material composite (TiO₂/SiOx/C) was confirmed even at 5 A g⁻¹, and the reversible capacity was maintained at >450 mAh g⁻¹ even after 1,000 cycles. The coulombic efficiency remained about 98% after 1,000 cycles, demonstrating excellent cycle characteristics resulting from the structural stability of the silicon negative electrode material based on the silicon-based active material composite (TiO₂/SiOx/C).

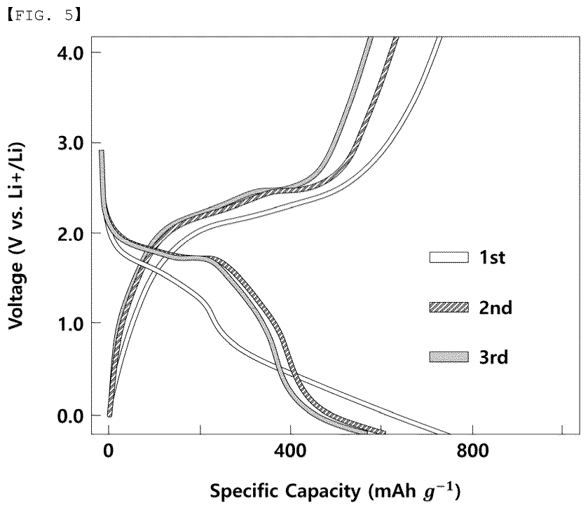

FIG. 5 shows the charge/discharge characteristics of a battery using the silicon-based active material composite as the negative active material.

Referring to FIG. 5, at 0.1 C, the silicon-based active material composite (TiO₂/SiOx/C) exhibited capacities of 589 mAh/g and 604 mAh/g, respectively. At 0.1 C and 0.5 C, the silicon negative electrode material based on the silicon-based active material composite (TiO₂/SiOx/C) exhibited high capacities in the unit cell evaluation, which is attributed to the increased specific surface area and structural stability resulting from the core-shell structure of the silicon-based active material composite (TiO₂/SiOx/C). The improved capacity is also predicted to result from the alloying reaction of SiOx during charge/discharge. Charge/discharge tests demonstrated that a battery using a silicon negative electrode material based on a silicon-based active material composite (TiO₂/SiOx/C) exhibited excellent electrochemical characteristics. This is because the TiO₂ nanocrystal structure and carbon matrix effectively buffered the volume expansion during the lithiation process of SiOx and maintained the stability of the nanostructure. In addition, SiOx played a key role in enhancing the capacity of the silicon-based active material composite (TiO₂/SiOx/C) structure due to its high theoretical capacity. The carbon matrix effectively encapsulated TiO₂ and SiOx, thereby suppressing non-uniform nanoparticle aggregation and enabling fast electron transport channels. Moreover, the porous structure of the silicon-based active material composite (TiO₂/SiOx/C) promoted fast Li⁺ migration due to its high porosity and large specific surface area.

The negative active material according to an embodiment of the present disclosure has excellent electrochemical performance and outstanding stability by including a silicon-based active material composite formed in a core-shell structure.

The negative active material according to an embodiment of the present disclosure has high capacity by including a silicon negative electrode material and has excellent cycle characteristics due to its structural stability.

The disclosed embodiments have been described above with reference to the attached drawings. A person having ordinary skill in the art to which the present disclosure pertains will understand that the present disclosure can be embodied in forms different from the embodiments disclosed herein without changing its technical spirit or essential features. The embodiments disclosed herein are illustrative and not be construed as limiting.

### DESCRIPTION OF REFERENCE SIGNS

1: Negative Active Material
10: Silicon-Based Active Material Composite
11: Silicon Oxide
12: Titanium Oxide
13: Carbon Material
20: Carbon-Based Active Material

What is claimed is:

1. A negative active material comprising:
a silicon-based active material composite; and
a carbon-based active material,
wherein the silicon-based active material composite includes silicon oxide (SiOx, 0<x≤2), titanium oxide (TiOx, 0<x≤2), and a carbon material.

2. The negative active material of claim 1, wherein the silicon-based active material composite includes a core including silicon oxide (SiOx, 0<x≤2) and titanium oxide (TiOx, 0<x≤2), and a shell including a carbon material.

3. The negative active material of claim 2, wherein the core has a structure in which the silicon oxide (SiOx, 0<x≤2) forms an amorphous matrix and the titanium oxide (TiOx, 0<x≤2) is embedded within the matrix.

4. The negative active material of claim 2, wherein the carbon material includes a carbon quantum dot (CQD).

5. The negative active material of claim 1, wherein the CQD has an average particle size of 1 to 100 nm.

6. The negative active material of claim 1, wherein the silicon oxide (SiOx, 0<x≤2) is included in an amount more than or equal to 3 wt % and less than 25 wt % based on 100 parts by weight of the negative active material.

7. The negative active material of claim 1, wherein the titanium oxide has an average particle size of 0.5 to 50 nm.

8. The negative active material of claim 7, wherein the titanium oxide includes an anatase-type TiO₂.

9. The negative active material of claim 1, wherein the silicon-based active material composite has an average particle size (D₅₀) of 1 to 10 um.

10. The negative active material of claim 1, wherein the carbon-based active material includes at least one of natural graphite, artificial graphite, and amorphous carbon.

11. The negative active material of claim 10, wherein the carbon-based active material is included in an amount more than or equal to 50 wt % and less than 97 wt % based on 100 parts by weight of the negative active material.

12. A lithium secondary battery comprising:
a negative electrode including the negative active material of claim 1;
a positive electrode including a positive active material; and
an electrolyte that transfers lithium ions to the positive electrode and the negative electrode.
